(19) United States
(12) Patent Application Publication
(10) Pub. No.: US 2005/0040335 A1
(43) Pub. Date: Feb. 24, 2005

(54) Spectroscopic determination of concentration in rectification column

(76) Inventors: Torsten Hauschild, Gladbach (DE); Martin Gerlach, Dormagen (DE); Stephan Tosch, Sprockhovel (DE); Burkhard Frisch, Leverkusen (DE); Bernd Mohr, Leverkusen (DE)

Correspondence Address: LANXESS CORPORATION;PATENT DEPARTMENT/ BLDG 14, 100 BAYER ROAD, PITTSBURGH, PA, 15205-9741, US

(21) Appl. No.: 10/914,557

(22) Filed: Aug. 9, 2004

(30) Foreign Application Priority Data
Aug. 11, 2003 (DE) 10336875.2

(51) Int. Cl. G01N 21/35

(52) U.S. Cl. 250/339.13

(57) ABSTRACT

The present invention relates to a method for determining the concentration in a rectification column by means of IR spectroscopy, wherein the sample is taken under hydrostatic control.

The present invention relates to a method for determining concentration in a rectification column by means of IR spectroscopy.

To prepare products having commercial purity, it is of great importance to provide suitable analysis methods which can intervene very early in the purification process and thus enable early recognition of faults in the process.

To this end, it is necessary, even within the rectification column, referred to hereinbelow as the column, to be able to undertake analytical purity testing by means of a suitable analysis method. A possibility here is the determination of the concentration of the substance to be purified and its impurities, for example by means of online gas chromatography, Raman, infrared (IR) or NMR spectroscopy.

The determination of concentration in a column is known. Online gas chromatographs are widespread and generally take samples from the columns (for example vacuum columns) by means of conveying units and conduct them to gas chromatography analysis. The analysis time is generally dependent on the dead volume of the sampling section and on the retention time of the substances involved (Henry Z. Kister, Distillation Operation, 1990, McGraw-Hill, pages 568-575).

The application of IR spectroscopy as the concentration determination in the withdrawal stream of a column is likewise known (WO 98/29787 A1). However, an adverse effect in this method is that the analysis in the withdrawal stream, where the specified product quality is generally already required, only recognizes a deviation in the end product of the purification process and thus any error in the process control can only be remedied at a very late stage. In the event of a recognized deviation, this results in a considerable amount of purified products being outside the intended specification range.

In addition, the analyses often have to be performed at a high concentration level, i.e. concentration values having contents of more than 99% by weight, so that the analysis precision required for closed-loop control is often not achieved.

In order to counteract these disadvantages, one possibility is to determine concentration actually within the column, which may be carried out within a safe margin to the required specification and at concentration levels which are easier to determine, but generally requires complicated closed-loop control technology using additional conveying units.

A further difficulty which generally arises in the positioning of an analysis probe for determining concentration within a column is the contamination of the system in the case of continuous sampling and subsequent feeding back into the column.

Additionally required for a successful, i.e. proportionate and rapid, reaction to recognized deviations is a high cycle frequency of the determination of concentration and thus also of sampling, rapid determination of the analysis results and also transmission, likewise at a high cycle frequency, of these analysis values to a process control system which controls the process and closed-loop control.

WO 98/29787 A1 describes a method for online control of industrial production processes using spectroscopic methods with emphasis on the use of NIR spectroscopy (near infrared spectroscopy). However, it goes neither into the positioning of the spectroscopic analysis probes nor into the alleviation of the above-described disadvantages, since the emphasis is rather on the online method in itself.

The object of the present invention is to provide a simple method for spectroscopic determination of concentration in a rectification column which no longer has the above-described disadvantages.

The present invention provides a method for spectroscopically determining the concentration of a substance in a rectification column, characterized in that
1) the concentration of the substance is determined by means of IR spectroscopy,
2) a sample loop is conducted out of the rectification column at a certain height Hₒ and introduced back into the rectification column below the outlet at a height Hᵤ, resulting in a height differential ΔH,
3) the sample is taken under hydrostatic control and via the sample loop by building up a hydrostatic pressure level in the sample loop which is higher than the pressure drop in the column section relevant to the height differential ΔH, and
4) an analysis line (bypass line) branches off from the sample loop and is conducted back into the sample loop, and conducts the liquid to be analysed past an IR analysis probe.

This is preferably a method, characterized in that the rectification column is operated in the reduced pressure range.

This is more preferably a method, characterized in that the concentration is determined by means of NIR spectroscopy.

Surprisingly, the method according to the invention does not have the disadvantages listed at the outset.

A sample loop was installed on the column and was designed purely from a hydrostatic point of view. The sample loop was attached at the lower edge of a structured packing bed of the column, i.e. in the liquid collector installed there. The liquid is conducted out of the column and can get into the downpipe by means of a degassing nozzle without gas bubbles being entrained to a significant extent. The sample loop is introduced back into the column after a few metres of height loss (ΔH). This is possible since a hydrostatic pressure level builds up across the sample loop and is higher than the pressure drop of the relevant column section. The optimum adjustment of height differential, preferably from approx. 3 to 7 m, hydrostatic pressure resulting from the height differential minus the pressure drop resulting from the sample loop, preferably from approx. 0.1 to 0.4 bar, and pressure drop within the relevant column section, preferably from approx. 0.01 to 0.2 bar, makes possible simple continuous sampling and feedback without additional conveying units.

In addition, the liquid may be introduced back into the column, since the liquid amounts are small in comparison to the amounts flowing internally in the column and there is consequently no danger of product contamination, i.e. “poisoning” of the system. A further segment of structured packings below this inlet point additionally protects the product quality. From the abovementioned sample loop, a bypass line (analysis line) branches off and conducts the liquid past an IR analysis probe. This probe includes a preferably internal degassing loop and is designed for high temperatures. Calibration samples may also be taken from the analysis line. The degassing loop is a constituent of the probe block. Upstream of the optical system of the analysis probe, the capture of the concentration signal, any gas bubbles present in the sample liquid are provided with the possibility of degassing out of the liquid by a bypass line leading past the optical system.

A preferred embodiment of the method according to the invention is thus characterized in that the analysis line
1) includes a degassing loop,
2) is designed for temperatures of 0° C. to 180° C., preferably 60° C. to 180° C., more preferably 100° C. to 180° C.,
3) may be heated and
4) calibration samples may be taken from the analysis line.

The arrangement described is capable of carrying out the determination of concentration in a one-minute frequency. Since the high end purity of the product is not yet required at this point in the concentration profile of the column, the analysis precision achieved of 0.1% is sufficient to obtain a utilizable control signal for online closed-loop control. The early recognition of deviations may result in an implicit amplification of fault recognition by a factor of 10 and more, which may be utilized to control the process in the column.

The residence time of the liquid in the analysis line, also referred to hereinbelow as the bypass line, up to the IR probe is minimized to the extent that the propagation time of a deviation or fault within the column recognized at the IR probe is smaller than the required intervention time of the installed column closed-loop control circuit.

For calibration, is installed in the analysis line (bypass line) is the means of taking a representative reference sample. For calibration, a number of at least 40 reference samples is required. The substance composition of the samples is determined in the laboratory by means of reference analysis. The analysis values are each assigned to a spectrum and chemometric evaluation methods (multivariate calibration) are used to produce a correlation between the spectra and the substance composition of the samples. The result is a chemometric calibration model. Chemometric evaluation methods are a mathematical algorithm by which the change in recorded IR spectra is correlated to a change in concentration. These evaluation methods are nontrivial, but can also performed at the local level since high-performance PCs have been introduced (Harald Martens, Tormod Naes, Multivariate Calibration, 1997, John Wiley & Sons).

The chemometric calibration model is used to calculate the substance composition of the sample to be analysed for the IR spectra measured from the sample stream of the analysis line. The analysis result may either be transmitted as a 4 to 20 mA signal or digitally.

The method according to the invention may be carried out in various embodiments of rectification columns, for example tray columns or columns having structured packing. The decisive factors are the adjustment of the geodetic height differential used, the pressure drop over the analysis loop and the pressure drop over the analysed section of the rectification column. Preference is given to carrying out the method according to the invention in columns having structured packing.

Among other benefits, the low pressure drop of the IR probes, in particular of the NIR probes, enables very simple installation under vacuum conditions because the sample loop may be executed in an acceptable regime from a separation technology point of view. In an acceptable regime from a separation technology point of view, no cross-contamination occurs and a concentration shift within the rectification column is recognized sufficiently rapidly that early manual or automatic interventions, preferably automatic interventions, keep the execution of the separation task still at the optimum operating point. The industrial installation also requires no metering or conveying pumps.

The method according to the invention allows substance mixtures to be separated or substances to be freed of undesired impurities. The substances may be organic or inorganic compounds which have a boiling point suitable for a rectification. Preference is given to individual isomers or isomer mixtures of organic compounds, oligo- or polymers, azeotropic mixtures, etc. Particularly suitable substances are, for example, the different nitrotoluenes, chloronitrobenzenes and chlorotoluenes. The substances, according to their specification, should not contain, or not contain higher than the specified concentration of, any impurities.

### EXAMPLE

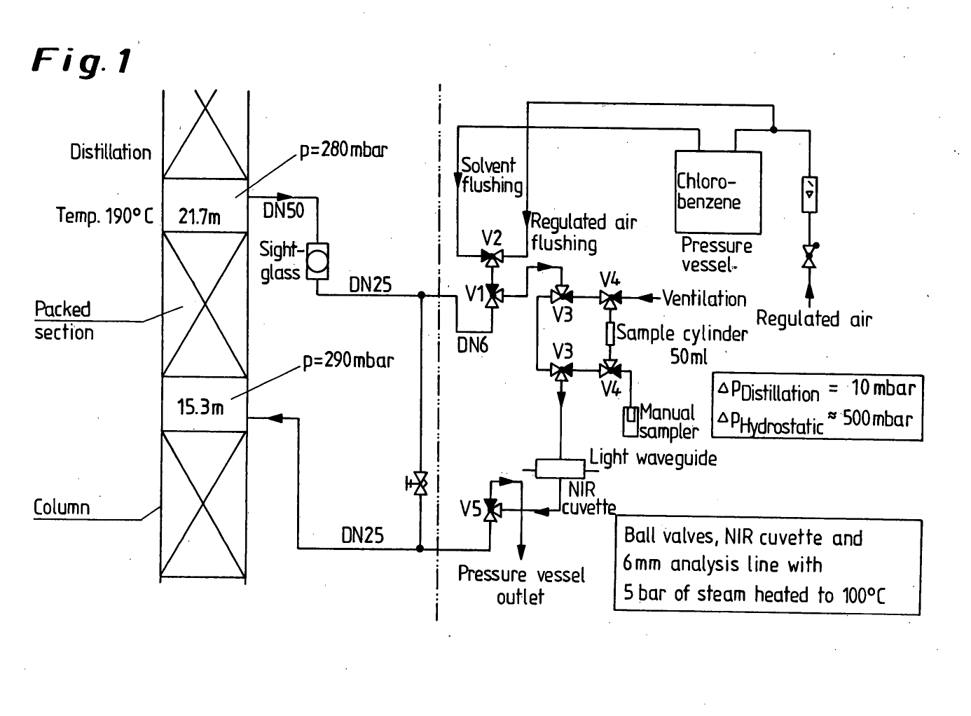

The method according to the invention is illustrated using a rectification column for chloronitrobenzene isomer separation (see FIG. 1).

The sample loop is attached to the column at a geodetic height of approx. 21.7 m. The internal column pressure at this position is approx. 280 mbar. A DN50 tube (DN: diameter specification according to the German industrial standard) leads downwards from the liquid collector into a DN25 sample loop which opens back into the rectification column at a geodetic height of approx. 15.3 m. At this opening, there is an internal column pressure in the column of approx. 290 mbar. The pressure differential in the column, resulting from the column internals of a structured packing section used here, has an available geodetic height differential of approx. 6.4 m. This geodetic height differential, minus the 10 mbar of pressure rise in the column, may be utilized in the sample loop in order to conduct the liquid past the NIR probe.

The sample loop branches off from the DN25 cross section into a DN6 bypass line (analysis line). The cross-sectional reduction was selected in order to keep the holdup, i.e. the volume of liquid retained in the relevant section, very low within the entire sampling apparatus. The bypass is equipped with fittings and connections in order to flush the area with solvent (for example chlorobenzene), or else in order to take reference samples in the immediate area of the NIR probe by manual sampling. The NIR cuvette having light waveguide connection is likewise disposed in this DN6 bypass system. The light waveguide transmits the signal from the cuvette installation point to the evaluation unit of the NIR signal.

If required, for example for flushing purposes, the DN6 bypass line is emptied via ball valves and automatically flushed with solvents. In addition, this allows blank spectra to be recorded.

In addition, the NIR spectrometer is disposed in a space outside the explosion protection zone which is prescribed in many production sites of chemical or petrochemical plants.

As a result of the experimental system described, concentration values of 97% by weight of chloronitrobenzene isomer with a precision of approx. 0.1% are achieved for the concentration level of the relevant installation point.

1. Method for spectroscopically determining the concentration of a substance in a rectification column, comprising:
1) determining the concentration of the substance by means of IR spectroscopy,
2) conducting a sample loop of the rectification column at a certain height Hₒ and introducing the sample back into the rectification column below the outlet at a height Hᵤ, resulting in a height differential ΔH,
3) taking the sample under hydrostatic control and via the sample loop by building up a hydrostatic pressure level in the sample loop which is higher than the pressure drop in the column section relevant to the height differential ΔH, and
4) branching off an analysis line (bypass line) from the sample loop and conducting back the line back into the sample loop, and conducting the liquid to be analysed past an IR analysis probe.

2. The method according to claim 1, wherein the rectification column is operated in the reduced pressure range.

3. The method according to claim 1, wherein the concentration is determined by means of NIR spectroscopy.

4. The method according to claim 1, wherein the analysis line
1) includes a degassing loop,
2) is designed for temperatures of from 0° C. to 180° C.,
3) can be heated and
4) calibration samples can be taken from the analysis line
